(19) United States
(12) Patent Application Publication
(10) Pub. No.: US 2004/0073426 A1
(43) Pub. Date: Apr. 15, 2004

(54) Method for storing acoustic information and a method for selecting information stored

(76) Inventor: Thomas Jung, Bielefeld (DE)

Correspondence Address: KENYON & KENYON, ONE BROADWAY, NEW YORK, NY, 10004, US

(21) Appl. No.: 10/450,086

(22) PCT Filed: Nov. 27, 2001
(86) PCT No.: PCT/DE01/04464

(30) Foreign Application Priority Data
Dec. 5, 2000 (DE) 10060295.9

(51) Int. Cl. G10L 15/00

(52) U.S. Cl. 704/246

(57) ABSTRACT

A method for storing acoustic information is described, characterized in that the information to be stored is combined into groups, and each group of information to be stored is assigned a group identifier characterizing that particular group, as well as a method for selecting information stored by the method according to the present invention, said information being characterized in that after input of a group identifier, preferably voice input via a microphone, a particular group of information is selected.

The present invention permits a particularly rapid means of retrieving and selecting voice information stored in a voice memory.

### BACKGROUND INFORMATION

The present invention is directed to a method for storing acoustic information and a method for selecting information stored by this method according to the preamble of the independent claims.

There is known dictation equipment with which voice information picked up by a microphone is stored successively on magnetic tape. For access to a certain portion of the stored information, e.g., a certain dictation, it is necessary to rewind the tape until reaching the start of the desired dictation, for example.

In addition, there are known playback devices for compact cassettes (CC) which automatically recognize the start of information stored on tape on the basis of an audio signal pause on the tape immediately preceding the information. Access to a very specific desired dictation or piece of music is also impossible with these known CC playback devices.

### ADVANTAGES OF THE INVENTION

The method according to the present invention having the features of the first independent patent claim has the advantage over the related art that certain stored information of the totality stored by the method according to the present invention is more rapidly and more reliably retrievable. For this purpose, the information to be stored is combined into groups and with each group of information to be stored, a group identifier characterizing it is also stored.

The advantage of the method described here is derived in particular in conjunction with a digital voice memory which permits rapid access time and thus also rapid retrieval of certain stored information.

Advantageous embodiments and refinements are characterized in the following dependent claims.

It is thus particularly advantageous that for each item of information stored, an identifier characterizing it is also stored. This yields a further improvement with regard to the retrievability of certain recorded acoustic information of a quantity of such information and thus yields a shortened access time to this certain information.

In addition, it is particularly advantageous that the identifiers or group identifiers are acoustic signals, in particular voice information, preferably spoken by the user and picked up by a microphone. Using acoustic information as identifiers and/or group identifiers permits completely acoustic operation of a device for storage of acoustic information according to the present invention. In addition, the identifiers or group identifiers can be predetermined individually by the user in accordance with the user's wishes and concepts in an advantageous manner.

The method according to the present invention of selecting information stored by a method according to one of the preceding claims according to the second independent patent claim permits rapid and effective access to certain stored acoustic information. This is accomplished by selecting a particular group of information after input of a group identifier, preferably voice input via a microphone.

It is also advantageous that when a separate identifier has not been stored for each individual bit of information, or only one group identifier has been input for selection of information, e.g., because the identifier of a certain desired information is not known, the information of the selected group of information is output successively in a certain order, preferably acoustically, the order being determined according to a sorting criterion.

It is also advantageous if after input of an identifier, preferably voice input via a microphone, information assigned to this identifier is selected. This permits particularly rapid and reliable access to certain recorded acoustic information out of a quantity of such information.

Finally, it is advantageous if a device, in particular a vehicle information system, has voice control, so that both storage and selection of stored acoustic information are controlled by voice commands picked up by a microphone.

The methods according to the present invention having the features of the independent patent claims or the dependent patent claims in addition may be used in a particularly advantageous manner for storing voice information of different categories picked up by a microphone in a vehicle information system. With known vehicle information systems which feature manual operation and visual feedback, there is a considerable potential risk for the driver of the vehicle and other drivers on the road because of the distraction from driving associated with operation of these devices. The present invention, in contrast, permits a particularly safe means of operating a voice recording unit because it is associated with a very small degree of distraction. This may be used, for example, for recording dictation, for recording personal notes such as recollections of certain events or data or address information and telephone information.

### DRAWINGS

Exemplary embodiments are illustrated in the drawing and explained in greater detail below.

FIG. 1 shows a system for performing a method according to the present invention on the example of a vehicle information system.

FIGS. 2A, 2B, 2C and 2D show flow charts of the methods according to the present invention.

### DESCRIPTION OF THE EMBODIMENTS

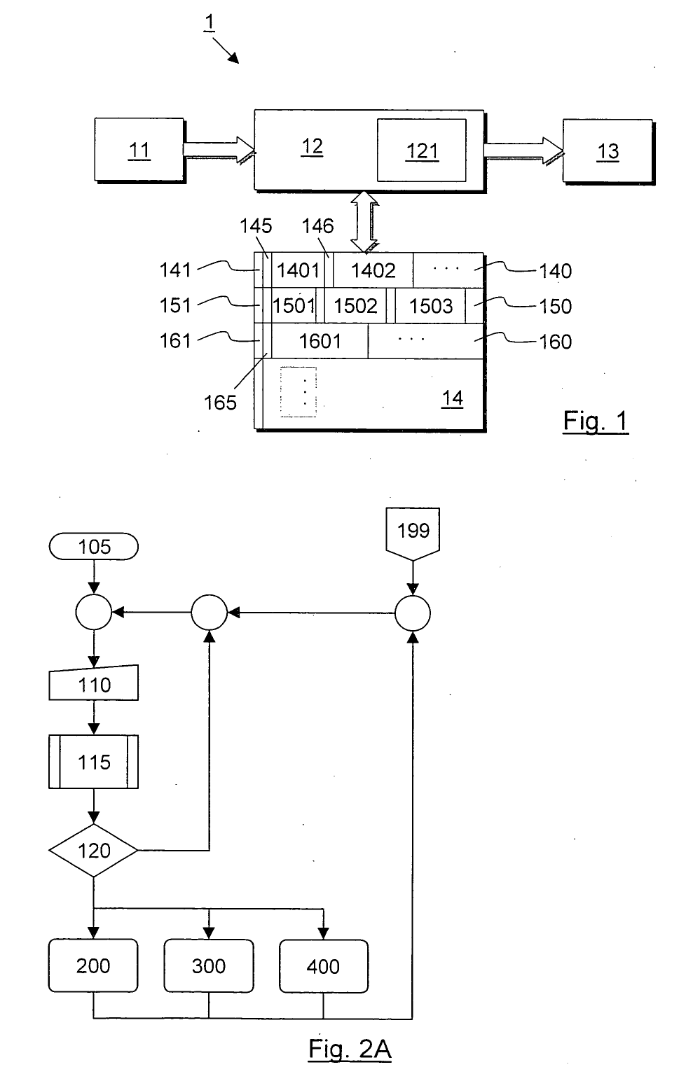

FIG. 1 shows as an example a block diagram of a portion of a vehicle information system according to the present invention that is essential to the present invention for performing the methods according to the present invention.

Vehicle information system 1 includes a recording device 11 for acoustic signals, the device being designed in the present case in the form of a microphone for picking up voice information spoken by the user. The microphone signals are sent to a device controller 12, which is implemented in the form of operating software installed in a microprocessor. Controller 12 includes a voice recognition device 121 which is implemented in the form of a routine of the operating software of controller 12.

Voice recognition device 121 is designed so that voice patterns for a given quantity of voice commands are stored in a memory. A routine for execution of a corresponding command is assigned to each voice pattern in the memory of the voice recognition device. This assignment is advantageously implemented in the form of a reference to a corresponding entry address of the operating program of controller 12. If voice recognition device 121 recognizes a match with one of the stored voice patterns on the basis of a comparison of a voice signal picked up by microphone 11 with a voice pattern stored in its memory, it generates a coincidence signal which characterizes the recognized voice pattern and triggers the processing of the particular command, i.e., the software routine required for it.

Controller 12 is connected to a voice memory 14 which is preferably implemented as a digital voice memory. The voice memory is subdivided into memory areas 140, 150, 160, each memory area being assigned to a certain group of recorded information or information to be recorded, such as dictation (first memory area 140), notes (second memory area 150) and address information (third memory area 160). Each memory area 140, 150 and 160 is assigned a group identifier 141, 151 and 161 characterizing the particular area. These group identifiers are preferably implemented in the form of voice information input by the user via the microphone such as “dictation” for the first group identifier 140 of the first memory area, “notes” for second memory area 151 and “addresses” for third memory area 161.

A first dictation 1401 and a second dictation 1402 are stored in voice memory 14 shown in FIG. 1, e.g., in first memory area 140, which is reserved for dictation and is labeled by the group identifier “dictation” 141. An individual information identifier 145 and 146 is assigned to each of the two dictations 1401 and 1402, preferably again being implemented in the form of a voice signal, e.g., in the form of “dictation on Nov. 2, 12:00 noon” (identifier 145) and “dictation on Nov. 3, 1:00 p.m.” (second identifier 146). Similarly, individual identifiers are assigned to voice notes 1501, 1502 and 1503 in the second memory area of memory 14 and address information 1601 (third identifier 165) in third memory area 160 of the memory. Each item of voice information stored in memory 14 is retrievable on the basis of group identifier 141, 151, 161 and identifier 145, 146, 165 assigned to each item of information.

In a first embodiment of memory 14, it is implemented in the form of a digital memory. In this case, group identifiers 141 through 161 and identifiers 145 through 165 are stored in voice memory 14 itself. As an alternative, however, it is also possible for the actual identifiers and group identifiers to be stored in voice recognition device 121 of controller 12 and for an address to be assigned to them, this address marking the start of the first through third memory areas in the case of group identifier 141 through 161, or marking the address of the voice information stored in memory 14 in the case of the identifiers.

The voice management mentioned last, in which addresses in the memory are assigned to the voice identifiers and voice group identifiers, is also suitable in principle for a memory medium in which all voice information is recorded successively, as is the case with magnetic tape. In this case, the address may be a tape running time or a counter reading on the tape counter mechanism, so that the particular information group or information is selectable by winding the magnetic tape forward or in reverse to the counter reading assigned to an identifier or to a group identifier.

Information selected in the manner described here is outputable via an acoustic playback device 13 connected to controller 12.

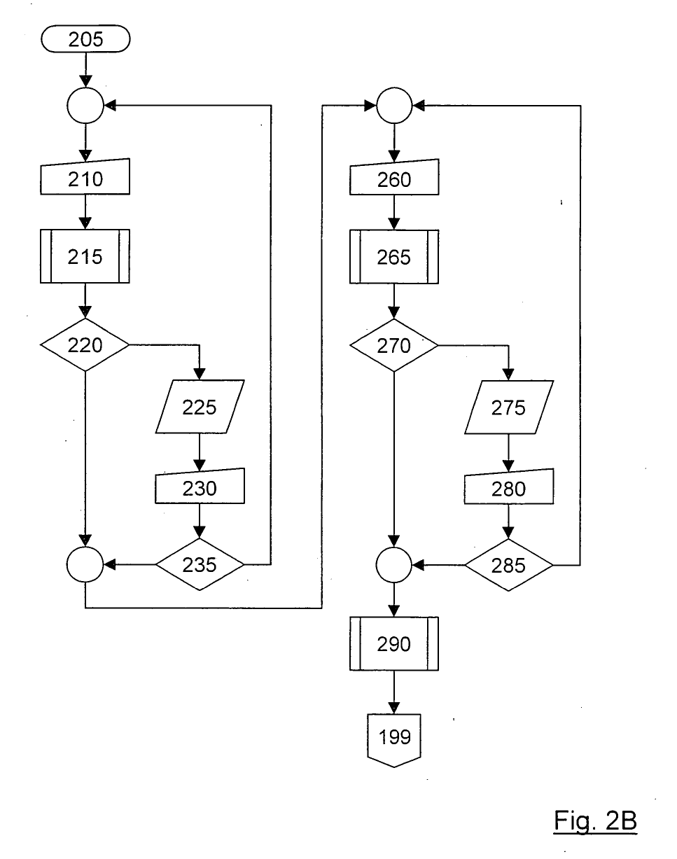

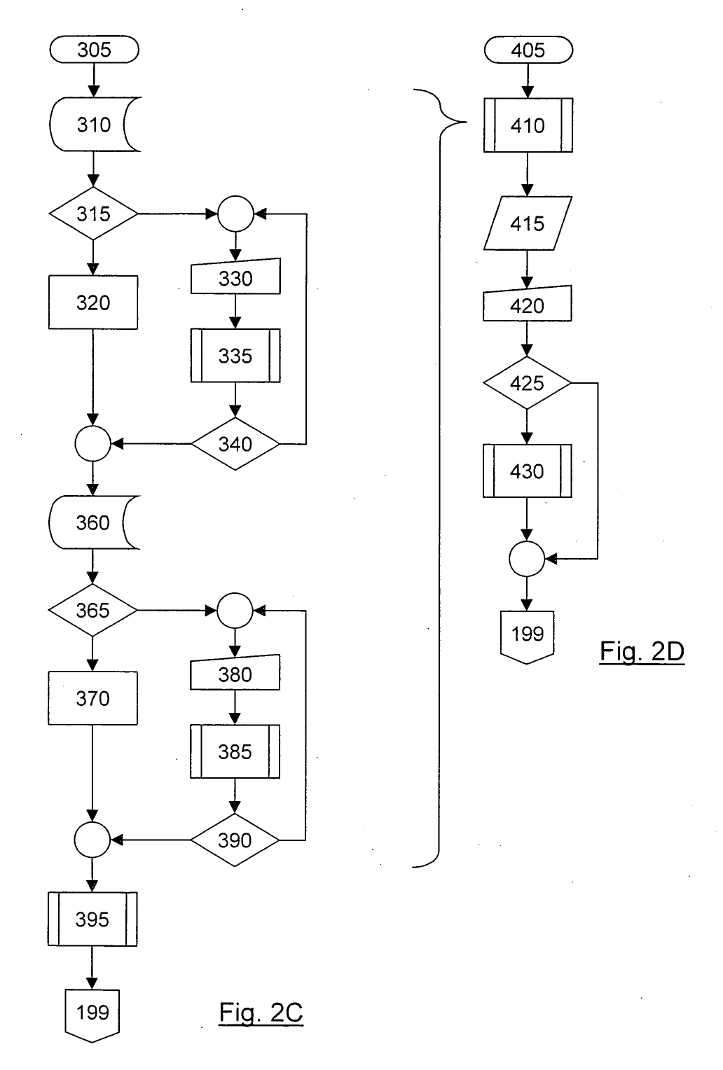

The methods according to the present invention are explained in greater detail below on the basis of the flow charts shown in FIGS. 2A, 2B, 2C and 2D.

The sequence begins at step 105 by turning on vehicle information system 1, which is operated in a motor vehicle. In step 110 there is voice input by the user via microphone 11, a command for controlling device 1 being expected as voice input in step 110. In step 115 the voice input in step 110 is compared with voice patterns stored in voice recognition device 121 for commands for controlling the vehicle information system. If no match is found between the voice input and the stored voice patterns in step 120, the sequence returns to step 110, where new voice input is expected via microphone 11. However, if a match between the voice input and a stored voice pattern is found in step 120, an action 200, 300 or 400 assigned to the recognized voice command is triggered subsequently.

If the “record” command, for example, is input via microphone 11 in step 110, then recording routine 200, which is included in FIG. 2B, is started at step 205. After the start of the recording routine, voice input of a group identifier, i.e., one of the terms “dictation,” “notes,” or “addresses” is expected in step 210 in the case of the exemplary embodiment described in FIG. 1. After voice input of a group identifier in step 210, the match between the voice input and a group identifier stored in voice memory 114, i.e., voice recognition device 121, is checked in step 215. If it is not a match, then in step 225 a corresponding output, preferably acoustic output via acoustic output device 13, is generated, providing acoustic playback of the voice pattern recognized as a result of the voice input and requesting the user for further input to indicate whether the group identifier thus input is a new group identifier or perhaps a group identifier that was spoken unintelligibly. A corresponding input by the user for confirmation of the new group identifier or for discarding the voice input is expected in step 230. If it is found in step 235 that the voice input in step 210 is an unintelligible input of an existing group identifier, then the sequence returns to step 210, where renewed input of a group identifier is expected. Otherwise the voice input in step 210 is accepted as a new group identifier, which is then assigned to a new memory area of memory 14.

For the case not shown in FIG. 2B, i.e., when identifiers are not provided for individual items of acoustic voice information, then the next free memory cell in memory areas 140 through 160 of voice memory 14, characterized by the input voice identifier, is determined for recording the voice information to be input subsequently, and the voice information input via microphone 11 is entered into this memory cell of memory 14 (step 290). The sequence then returns to step 110 via entry point 199, so renewed input of a voice command is expected for controlling vehicle information system 1.

In the case illustrated in FIG. 2B, in which each item of voice information is assigned a separate identifier 145, 146, 165 characterizing that particular item, the input of an identifier is expected in step 260. An identifier input via microphone 11 is compared in step 265 which follows with identifiers present in the memory, i.e., in the voice recognition device. For example, the system may provide standard identifiers, e.g., “dictation 1” (145), “dictation 2” (145), etc. If it is found in step 265 that the identifier input by voice does not match an identifier provided by the system, then the sequence branches off in step 270 to step 275, where the voice pattern determined from voice input is played back acoustically via playback device 13 and the user is requested to confirm or discard the identifier thus input. In step 280 the identifier input is confirmed or discarded by voice input by the user. In the case when the identifier is discarded, the sequence branches back in step 285 to step 260, where renewed voice input of an identifier is expected.

If the identifier input is accepted by the user in step 280, however, or if a match between the voice input and an identifier provided by the system is found in step 265, then in the next step 290, as described above, voice information input via microphone 11 is recorded in voice memory 14, which is marked by the identifier thus input. Then the sequence returns to step 110 in FIG. 2A via entry point 199.

If in step 115 of the sequence according to FIG. 2A, the “playback” command is input in step 110, and in step 115 its match to a corresponding voice pattern in the memory of voice recognition device 121 is ascertained, then sequence 300 shown in FIG. 2C is executed for selection and playback of an item of voice information stored according to the procedure described above. Sequence 300 for selection and playback of a recorded item of voice information begins with step 305. In step 310 a check is first performed to determine whether there-is more than one memory area 140 in memory 14, i.e., whether information from more than one information group is stored in memory 14. If information from a plurality of information groups is stored in the memory, the sequence will branch off at step 315 to step 330, where input of a group identifier 141, 151 or 161 via microphone 11 is expected. Voice input made via the microphone in step 335 is compared with group identifiers stored in memory 14, i.e., the memory of voice recognition device 121. If the match between the voice input and a stored voice pattern of a group identifier is not recognized in 335, the sequence will branch off at step 340 for renewed voice input of a group identifier in step 330. However, if a group identifier is recognized, the sequence branches off to downstream step 360.

For the case when the existence of only one single memory area 140 is ascertained in step 315, this memory area, i.e., its particular group identifier 141, is selected in step 320.

In next step 360, the controller checks on whether more than one item of voice information is stored in selected memory area 140, 150, 160, i.e., under selected group identifier 141, 151, 161. If this is not the case, the sequence branches off in step 365 to step 370, where the only item of voice information stored in the selected memory area is selected. This is then played back acoustically by acoustic playback device 13 in step 395. After conclusion of the playback of the selected voice information, the sequence returns to step 110 via entry point 199.

However, if it is found in step 365 that a plurality of items of voice information exist for the selected group identifier, then in subsequent step 380, the user is requested to input identifier 145, 146, 165 of voice information 1401, 1402, 1501, 1502, 1503, 1601 to be selected. If a match of the voice input to a stored information identifier is not found in step 385, the sequence branches back in step 390 to step 380, where renewed input of an identifier is expected. However, if a match of the voice input to a stored identifier is found, the information marked by this recognized identifier is selected and played back in step 395 via the voice output device as described above.

For the case which is not shown in the FIGURE, i.e., there are no identifiers for marking individual items of voice information in the voice memory, then in step 395 all the information stored in the memory for the selected group identifier is played back according to a predetermined sorting criterion, e.g., the age of the recordings.

If the “erase” command is entered in step 110 of the sequence in FIG. 2A, the method executes erase routine 400, which is shown in FIG. 2D. The erase routine begins at step 405. In the next step 410, steps 310 through 390, which have been described in conjunction with the selection and playback routine described above, are executed for the selection of information to be erased.

In next step 415, the controller outputs the group identifier and the identifier of the information to be erased, and according to a refinement of the present invention, it also outputs at least portions of the selected information, e.g., the first five seconds of the voice recording, via acoustic playback device 13. Then the user has an opportunity to stop the erase procedure for the selected information by a corresponding voice input “stop.” For this case, the sequence goes back to step 110 from branch point 425 via entry point 199 for input of a command for controlling the vehicle information system.

However, if erasing of the selected information is confirmed in step 420 by a corresponding voice input such as “erase,” then in next step 430, the selected information is erased from the voice memory. If identifier 146 assigned to erased voice information 1402 is an identifier predefined by the user via voice input, then this is also erased automatically in step 430. Finally, the sequence returns to input step 110 in FIG. 2A via entry point 199.

What is claimed is:

1. A method for storing acoustic information, wherein the information to be stored is combined into groups, and a group identifier characterizing this information is stored for each group of information to be stored.

2. The method as recited in claim 1, wherein for each item of information to be stored, an identifier characterizing this item of information is also stored.

3. The method as recited in claim 1 or 2, wherein the information is voice information picked up by a microphone.

4. The method as recited in one of the preceding claims, wherein the identifiers or group identifiers are implemented in acoustic form.

5. The method as recited in claim 4, wherein the identifiers or group identifiers are implemented as voice information.

6. The method as recited in claim 4 or 5, wherein the identifiers or group identifiers are information picked up by a microphone, in particular information spoken by the user.

7. The method as recited in one of claims 1 through 6, wherein after input of a group identifier, a group characterized by this identifier is selected, and an item of information that has been input is assigned to this group.

8. A method for selecting information stored according to a method as recited in one of the preceding claims 1 through 7, wherein after input, preferably voice input via a microphone, of a group identifier, an associated group of information is selected.

9. The method as recited in claim 8, wherein the information of the selected group of information is output successively, preferably acoustically, in an order that is determined according to a sorting criterion.

10. The method as recited in claim 8, wherein after input, preferably voice input via a microphone, of an identifier, an item of information assigned to this identifier is selected.

11. The method as recited in one of the preceding claims, wherein the storage or selection of stored information is controlled by voice commands picked up by a microphone.
